(19) United States
(12) Patent Application Publication
(10) Pub. No.: US 2026/0159692 A1
(43) Pub. Date: Jun. 11, 2026

(54) ASPHALT COMPOSITION WITH AN IMPROVED LIFE SPAN

(71) Applicant: SABIC GLOBAL TECHNOLOGIES B.V., Bergen op Zoom (NL)

(72) Inventors: Lidia Jasinska-Walc, Veldhoven (NL); Robbert Duchateau, Roostenlaan (NL); Miloud Bouyahyi, Eindhoven (NL); Mateusz Malus, Gdansk (PL); Maciej Sienkiewicz, Gdansk (PL); Maria Soliman, Selfkant (DE); Lanti Yang, Noord-Brabant (NL); Weronika Nowicka, Sittard (NL); Wojciech Szot, Czluchow (PL)

(21) Appl. No.: 19/129,229

(22) PCT Filed: Nov. 15, 2023
(86) PCT No.: PCT/EP2023/081869

§ 371 Date: May 12, 2025

(30) Foreign Application Priority Data
Nov. 15, 2022 (EP) 22207483.3
Dec. 13, 2022 (EP) 22213294.6

(51) Int. Cl. C08L 95/00; C08F 210/06

(52) U.S. Cl. CPC C08L 95/00; C08F 210/06; C08L 2555/52; C08L 2555/80

(57) ABSTRACT

A mineral adhesion promoter composition for bitumen including at least of a hydroxyl-functionalized propylene-based copolymer preferably having a hydroxyl-functionalized olefin comonomer content between 0.1 and 0.6 mol %, more preferably 0.2 to 0.5 mol %, and aluminum-containing residue including an elemental aluminum content from a quantity of 0.05 to 1.5 wt % of the hydroxyl-functionalized propylene-based copolymer; to a modified bitumen composition including at least: mineral adhesion promoter composition according to the invention and neat bitumen; and finally to an asphalt composition including the modified bitumen composition according to the invention and some mineral.

### TECHNICAL FIELD OF THE INVENTION

The present invention relates to an asphalt composition with an improved life span, a mineral adhesion promoter and its use in asphalt composition.

### TECHNOLOGICAL BACKGROUND OF THE INVENTION

Asphalt is generally constituted from a mixture comprising bitumen and minerals and optionally additives as amines, which are used as adhesion promoter to improve the affinity of the bitumen to the mineral. By improving the affinity of bitumen to the mineral, the asphalt composition is able to have a longer span life.

However, those amines are commonly considered as toxic component and could leak into the environment.

Therefore there is a need for a non-toxic adhesion promoter, which will not deteriorate the mechanical property of the bitumen below the standard such as its penetration, softening point, wheel tracking slope, Indirect tensile strength ratio, degree of binder coverage upon 6 h etc., and could eventually improve some of those parameters.

### SUMMARY

This object is achieved by the present invention.

In a first aspect the present invention relates to a mineral adhesion promoter composition for bitumen comprising
at least of a hydroxyl-functionalized propylene-based copolymer preferably having a Tₘ below 100° C., preferably below 90° C. more preferably below 85° C., even more preferably below 80° C. or be atactic and a hydroxyl-functionalized olefin comonomer content between 0.1 and 0.6 mol %, more preferably 0.2 to 0.5 mol %,
an aluminum-containing residue comprising an elemental aluminum content from a quantity of 0.05 to 1.5 wt % of the hydroxyl-functionalized propylene-based copolymer

In some embodiments, the hydroxyl-functionalized propylene-based copolymer is a polymer comprising propylene, optionally a second olefin monomer, and a hydroxyl functionalized olefin monomer.

In some embodiments, the hydroxyl-functionalized propylene-based copolymer is selected from the list comprising poly(propylene-co-5-hexen-1-ol), poly(propylene-co-ethylene-co-5-hexen-1-ol), poly(propylene-co-1-hexene-co-5-hexen-1-ol) or poly(propylene-co-1-octene-co-5-hexen-1-ol).

In a second aspect the present invention relates to a modified bitumen composition comprising at least:
Neat bitumen and
Mineral adhesion promoter according to the invention.

In some embodiments, the Modified bitumen composition have at least the followings:
Avg. Penetration<80 dmm according to European Standard 1426, and
Avg. softening>46° C. according to European Standard 1427, and
Δ Penetration<5 and/or A Softening point<5 according to European Standard 13399
Adhesion force>40 nN according to SABIC Internal QNM-AFM method
DMT modulus>1.75 GPa according to SABIC Internal QNM-AFM method
Degree of binder coverage on Granite [%]>=80, preferably >=90 according to PN-84/B-06714/22,
Degree of binder coverage on Limestone [%]>=60, preferably >=70, more preferably >=80 according to PN-84/B-06714/22,

In a third aspect the present invention relates to an asphalt composition comprising
Modified Bitumen composition according to invention, in a quantity of 1.0 to 10 wt % of the asphalt composition, and
Mineral in a quantity of 90 to 99.0 wt % of the asphalt composition, and
wherein the asphalt composition have at least the followings:
Coverage of aggregates surface on Granite [%] above 50, preferentially >=60 or above, more preferentially >=80 according to EN 12697-11 (method A)
Coverage of aggregates surface on Limestone [%] above 70, preferentially >=80 according to EN 12697-11 (method A)
Indirect tensile strength ratio ITSR [%]>=85, preferably >=90 according to EN 12697-12A, and
Wheel tracking slope WTS_{AIR} upon 10³ cycles [mm/10³ cycles]<0.10, according to EN 12697-22

In another aspect, the present invention relates to use of mineral adhesion promoter composition according to the invention, in modified bitumen composition or in an asphalt composition as mineral adhesion promoter.

In another aspect, the present invention relates to use of modified Bitumen composition according to the invention, in an asphalt composition or in roofing application.

In a final aspect, the present invention relates to use an asphalt composition according to the invention, in a road application or building application.

### DETAILED DESCRIPTION

The present invention relates to a new asphalt composition allowing a longer life span, by improving the affinity of bitumen to the mineral present within the composition of the asphalt.

In order to obtain such properties, a mineral adhesion promoter additive, which has the role of adhesion promoter, is added to the composition.

The commonly used mineral adhesion promoters are fatty aliphatic amines, such as the Teramin family of product from ICSO Chemical Production. This promoter enhances the adhesion to mineral aggregates, in particular acidic aggregates (granodiorite, granite, quartzite, porphyry).

However, due to the amine within their composition, those amine-based promoters are commonly considered as toxic components and could leak into the environment when the asphalt deteriorates.

Therefore, the goal of this invention is to present a new amine-free composition, which has better property as compared to neat bitumen and having similar or improved properties as bitumen comprising an amine-based mineral adhesion promoter in their composition.

Surprisingly, the inventors of the present application found that hydroxyl-functionalized propylene-based copolymers, preferably having a hydroxyl-functionalized comonomer content (or degree of OH-functionalization content) between 0.1 and 0.6 mol %, preferably between 0.1 to 0.5 mol %, more preferably 0.1 to 0.4 mol %, more preferably 0.2 to 0.5 mol %, more even preferably 0.2 to 0.4 mol %, even more between 0.2 or 0.3 mol %, are suitable to act as mineral adhesion promoter and a good alternative to amine-based mineral adhesion promoters.

Accordingly, the new “amine-free” asphalt composition according to the invention comprises at least:
a. Bitumen
b. Minerals
c. Additive package, which comprises at least a mineral adhesion promoter
   wherein the mineral adhesion promoter comprises a hydroxyl-functionalized propylene-based copolymer and an aluminum-containing residue,
   wherein the aluminum-containing residue comprising an elemental aluminum content as for example aluminum oxide and/or aluminum hydroxide and/or aluminum alkoxide,
   wherein the hydroxyl-functionalized propylene-based copolymer is a copolymer or propylene, a second non-functionalized olefin and a hydroxyl-functionalized olefin.

Preferably, the asphalt composition have at least the followings:
Avg. penetration<80 dmm according to EN 1426, and
Avg. softening>46° C. according to EN 1427, and
A penetration (ΔP)<5 and/or Δ softening point (ΔSP)<5 according to EN 13399, and
Coverage of aggregates surface on granite above 70%, preferentially 80% according to PN-84/B-06714/22 and
Indirect tensile strength ratio ITSR [%]>90 according to EN 12697-12A, and
Degree of binder coverage upon 6 h [%]>80 according to EN 12697-11, and
Wheel tracking slope WTS_{AIR} upon 10 000 cycles [mm/10³ cycles]<0.10, according to EN 12697-22

The hydroxyl-functionalized propylene-based copolymers is a polymer comprising propylene, optionally a second olefin monomer and a hydroxyl functionalized olefin, preferably having a hydroxyl-functionalized olefin comonomer content between 0.1 and 0.6 mol %, more preferably 0.2 to 0.5 mol %.

The common current technology to obtain an asphalt/bitumen composition require to use adhesion promoter to improve the affinity of the bitumen to the mineral, having a maximum melting temperature (Tₘ) of 135° C. as it is the one use in the process of making the asphalt/bitumen.

Surprisingly, the inventors discovered a threshold within the range of melting temperature (Tₘ) that need to be met in order to obtain an adhesion promoter suitable to be processed in an asphalt/bitumen composition and allowing good adhesion and physical (bulk) properties listed below.

Therefore, the hydroxyl-functionalized propylene-based copolymers according to the invention must have a Tₘ below 100° C., preferably below 90° C. more preferably 85° C., even more preferably below 80° C. and above 60° C. or be atactic, or syndiotactic.

The hydroxyl-functionalized propylene-based copolymer is either amorphous or semi-crystalline.

The second optional olefin monomer can be selected from the group comprising: ethylene, 1-butene, 1-hexene, 1-octene, 1-decene.

The hydroxyl-functionalized propylene-based copolymers can be produced in a solution process according to the process described in WO2022/106689 using the one of the following catalyst precursors: bis((2-oxoyl-3-(1,2,3,4,6,7,8,9-octahydroanthracen-5-yl)-5-(methyl)phenyl)-2-phenoxy)-1,3-propanediylhafnium (IV) dimethyl, bis((2-oxoyl-3-(1,2,3,4,6,7,8,9-octahydroanthracen-5-yl)-5-(methyl)phenyl)-2-phenoxy)-1,3-propanediylhafnium (IV) dichloride, bis((2-oxoyl-3-(1,2,3,4,6,7,8,9-octahydroanthracen-5-yl)-5-(methyl)phenyl)-2-phenoxy)-1,3-propanediylhafnium (IV) dibenzyl, bis((2-oxoyl-3-(dibenzo-1H-pyrrole-1-yl)-5-(methyl)phenyl)-2-phenoxy)-1,3-propanediylhafnium (IV) dimethyl, bis((2-oxoyl-3-(dibenzo-1H-pyrrole-1-yl)-5-(methyl)phenyl)-2-phenoxy)-1,3-propanediylhafnium (IV) dichloride, bis((2-oxoyl-3-(dibenzo-1H-pyrrole-1-yl)-5-(methyl)phenyl)-2-phenoxy)-1,3-propanediylhafnium (IV) dibenzyl, bis((2-oxoyl-3-(1,2,3,4,6,7,8,9-octahydroanthracen-5-yl)-5-(methyl)phenyl)-2-phenoxymethyl)-1,4-butanediylhafnium (IV) dimethyl, bis((2-oxoyl-3-(1,2,3,4,6,7,8,9-octahydroanthracen-5-yl)-5-(methyl)phenyl)-2-phenoxymethyl)-1,4-butanediylhafnium (IV) dichloride, bis((2-oxoyl-3-(1,2,3,4,6,7,8,9-octahydroanthracen-5-yl)-5-(methyl)phenyl)-2-phenoxymethyl)-1,4-butanediylhafnium (IV) dibenzyl, bis((2-oxoyl-3-(dibenzo-1H-pyrrole-1-yl)-5-(methyl)phenyl)-2-phenoxymethyl)-1,4-butanediylhafnium (IV)dimethyl, bis((2-oxoyl-3-(dibenzo-1H-pyrrole-1-yl)-5-(methyl)phenyl)-2-phenoxymethyl)-1,4-butanediylhafnium (IV) dichloride, bis((2-oxoyl-3-(dibenzo-1H-pyrrole-1-yl)-5-(methyl)phenyl)-2-phenoxymethyl)-1,4-butanediylhafnium (IV) dibenzyl, bis((2-oxoyl-3-(1,2,3,4,6,7,8,9-octahydroanthracen-5-yl)-5-(methyl)phenyl)-2-phenoxy)-2,4-pentanediylhafnium (IV) dimethyl, bis((2-oxoyl-3-(1,2,3,4,6,7,8,9-octahydroanthracen-5-yl)-5-(methyl)phenyl)-2-phenoxy)-2,4-pentanediylhafnium (IV) dichloride, bis((2-oxoyl-3-(1,2,3,4,6,7,8,9-octahydroanthracen-5-yl)-5-(methyl)phenyl)-2-phenoxy)-2,4-pentanediylhafnium (IV) dibenzyl, bis((2-oxoyl-3-(dibenzo-1H-pyrrole-1-yl)-5-(methyl)phenyl)-2-phenoxy)-2,4-pentanediylhafnium (IV) dimethyl, bis((2-oxoyl-3-(dibenzo-1H-pyrrole-1-yl)-5-(methyl)phenyl)-2-phenoxy)-2,4-pentanediylhafnium (IV) dichloride, bis((2-oxoyl-3-(dibenzo-1H-pyrrole-1-yl)-5-(methyl)phenyl)-2-phenoxy)-2,4-pentanediylhafnium (IV) dibenzyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dimethyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dichloride, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylhafnium (IV) dibenzyl, bis((2-oxoyl-3-(dibenzo-1H-pyrrole-1-yl)-5-(methyl)phenyl)-2-phenoxymethyl)-methylenetrans-1,2-cyclohexanediylhafnium (IV) dimethyl, bis((2-oxoyl-3-(dibenzo-1H-pyrrole-1-yl)-5-(methyl)phenyl)-2-phenoxymethyl)-methylenetrans-1,2-cyclohexanediylhafnium (IV) dichloride, and bis((2-oxoyl-3-(dibenzo-1H-pyrrole-1-yl)-5-(methyl)phenyl)-2-phenoxymethyl)-methylenetrans-1,2-cyclohexanediylhafnium (IV) dibenzyl, bis((2-oxoyl-3-(dibenzo-1H-pyrrole-1-yl)phenyl)-2-phenoxy)-1,3-propylhafnium (IV) dibenzyl, bis((2-oxoyl-3-(dibenzo-1H-pyrrole-1-yl)phenyl)-2-phenoxy)-1,4-n-butylhafnium (IV) dimethyl, bis((2-oxoyl-3-(dibenzo-1H-pyrrole-1-yl)phenyl)-2-phenoxy)-1,4-n-butylhafnium (IV) dibenzyl, bis((2-oxoyl-3-(3,6-bis(1,1-dimethylethyl)-9H-carbazolyl)phenyl)-2-phenoxy)-1,3-propylhafnium (IV) dimethyl, bis((2-oxoyl-3-(3,6-bis(1,1-dimethylethyl)-9H-carbazolyl)phenyl)-2-phenoxy)-1,3-propylhafnium (IV) dibenzyl, bis((2-oxoyl-3-(3,6-bis(1,1-dimethylethyl)-9H-carbazolyl)phenyl)-2-phenoxy)-1,4-n-butylhafnium (IV) dimethyl, bis((2-oxoyl-3-(3,6-bis(1,1-dimethylethyl)-9H-carbazolyl)phenyl)-2-phenoxy)-1,4-n-butylhafnium (IV) dibenzyl, bis((2-oxoyl-3-(4-methoxy-3,5-bis(1,1-dimethylethyl)phenyl)phenyl)-2-phenoxy)-1,4-n-butylhafnium (IV) dimethyl, bis((2-oxoyl-3-(4-methoxy-3,5-bis(1,1-dimethylethyl)phenyl)phenyl)-2-phenoxy)-1,4-n-butylhafnium (IV) dibenzyl, bis((2-oxoyl-3-(dibenzo-1H-pyrrole-1-yl)phenyl)-2-phenoxy)-1,2-ethylhafnium (IV) dimethyl, bis((2-oxoyl-3-(dibenzo-1H-pyrrole-1-yl)phenyl)-2-phenoxy)-1,2-ethylhafnium (IV) dibenzyl, bis((2-oxoyl-3-(dibenzo-1H-pyrrole-1-yl)phenyl)-2-phenoxy)-1,3-propylhafnium (IV) dimethyl; preferably bis((2-oxoyl-3-(dibenzo-1H-pyrrole-1-yl)-5-(methyl)phenyl)-2-phenoxy)-2,4-pentanediylhafnium (IV) dimethyl, bis((2-oxoyl-3-(dibenzo-1H-pyrrole-1-yl)-5-(methyl)phenyl)-2-phenoxy)-2,4-pentanediylhafnium (IV) dichloride; or a zirconium complex of a polyvalent aryloxyether selected from the group: bis((2-oxoyl-3-(dibenzo-1H-pyrrole-1-yl)-5-(methyl)phenyl)-2-phenoxy)-2,4-pentanediylzirconium (IV) dimethyl, bis((2-oxoyl-3-(dibenzo-1H-pyrrole-1-yl)-5-(methyl)phenyl)-2-phenoxy)-2,4-pentanediylzirconium (IV) dichloride, bis((2-oxoyl-3-(1,2,3,4,6,7,8,9-octahydroanthracen-5-yl)-5-(methyl)phenyl)-2-phenoxy)-1,3-propanediylzirconium (IV) dimethyl, bis((2-oxoyl-3-(1,2,3,4,6,7,8,9-octahydroanthracen-5-yl)-5-(methyl)phenyl)-2-phenoxy)-1,3-propanediylzirconium (IV) dichloride, bis((2-oxoyl-3-(1,2,3,4,6,7,8,9-octahydroanthracen-5-yl)-5-(methyl)phenyl)-2-phenoxy)-1,3-propanediylzirconium (IV) dibenzyl, bis((2-oxoyl-3-(dibenzo-1H-pyrrole-1-yl)-5-(methyl)phenyl)-2-phenoxy)-1,3-propanediylzirconium (IV) dimethyl, bis((2-oxoyl-3-(dibenzo-1H-pyrrole-1-yl)-5-(methyl)phenyl)-2-phenoxy)-1,3-propanediylzirconium (IV) dichloride, bis((2-oxoyl-3-(dibenzo-1H-pyrrole-1-yl)-5-(methyl)phenyl)-2-phenoxy)-1,3-propanediylzirconium (IV) dibenzyl, bis((2-oxoyl-3-(1,2,3,4,6,7,8,9-octahydroanthracen-5-yl)-5-(methyl)phenyl)-2-phenoxymethyl)-1,4-butanediylzirconium (IV) dimethyl, bis((2-oxoyl-3-(1,2,3,4,6,7,8,9-octahydroanthracen-5-yl)-5-(methyl)phenyl)-2-phenoxymethyl)-1,4-butanediylzirconium (IV) dichloride, bis((2-oxoyl-3-(1,2,3,4,6,7,8,9-octahydroanthracen-5-yl)-5-(methyl)phenyl)-2-phenoxymethyl)-1,4-butanediylzirconium (IV) dibenzyl, bis((2-oxoyl-3-(dibenzo-1H-pyrrole-1-yl)-5-(methyl)phenyl)-2-phenoxymethyl)-1,4-butanediylzirconium (IV)dimethyl, bis((2-oxoyl-3-(dibenzo-1H-pyrrole-1-yl)-5-(methyl)phenyl)-2-phenoxymethyl)-1,4-butanediylzirconium (IV) dichloride, bis((2-oxoyl-3-(dibenzo-1H-pyrrole-1-yl)-5-(methyl)phenyl)-2-phenoxymethyl)-1,4-butanediylzirconium (IV) dibenzyl, bis((2-oxoyl-3-(1,2,3,4,6,7,8,9-octahydroanthracen-5-yl)-5-(methyl)phenyl)-2-phenoxy)-2,4-pentanediylzirconium (IV) dimethyl, bis((2-oxoyl-3-(1,2,3,4,6,7,8,9-octahydroanthracen-5-yl)-5-(methyl)phenyl)-2-phenoxy)-2,4-pentanediylzirconium (IV) dichloride, bis((2-oxoyl-3-(1,2,3,4,6,7,8,9-octahydroanthracen-5-yl)-5-(methyl)phenyl)-2-phenoxy)-2,4-pentanediylzirconium (IV) dibenzyl, bis((2-oxoyl-3-(dibenzo-1H-pyrrole-1-yl)-5-(methyl)phenyl)-2-phenoxy)-2,4-pentanediylzirconium (IV) dibenzyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylzirconium (IV) dimethyl, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylzirconium (IV) dichloride, bis((2-oxoyl-3-(1,2,3,4,6,7,8,9-octahydroanthracen-5-yl)-5-(methyl)phenyl)-2-phenoxymethyl)-methylenetrans-1,2-cyclohexanediylzirconium (IV) dibenzyl, bis((2-oxoyl-3-(dibenzo-1H-pyrrole-1-yl)-5-(methyl)phenyl)-2-phenoxymethyl)-methylenetrans-1,2-cyclohexanediylzirconium (IV) dimethyl, bis((2-oxoyl-3-(dibenzo-1H-pyrrole-1-yl)-5-(methyl)phenyl)-2-phenoxymethyl)-methylenetrans-1,2-cyclohexanediylzirconium (IV) dichloride, and bis((2-oxoyl-3-(dibenzo-1H-pyrrole-1-yl)-5-(methyl)phenyl)-2-phenoxymethyl)-methylenetrans-1,2-cyclohexanediylzirconium (IV) dibenzyl, bis((2-oxoyl-3-(4-methoxy-3,5-bis(1,1-dimethylethyl)phenyl)phenyl)-2-phenoxy)-1,4-n-butylzirconium (IV) dimethyl, bis((2-oxoyl-3-(4-methoxy-3,5-bis(1,1-dimethylethyl)phenyl)phenyl)-2-phenoxy)-1,4-n-butylzirconium (IV) dibenzyl, bis((2-oxoyl-3-(dibenzo-1H-pyrrole-1-yl)phenyl)-2-phenoxy)-1,2-ethylzirconium (IV) dimethyl, bis((2-oxoyl-3-(dibenzo-1H-pyrrole-1-yl)phenyl)-2-phenoxy)-1,2-ethylzirconium (IV) dibenzyl, bis((2-oxoyl-3-(dibenzo-1H-pyrrole-1-yl)phenyl)-2-phenoxy)-1,3-propylzirconium (IV) dimethyl, bis((2-oxoyl-3-(dibenzo-1H-pyrrole-1-yl)phenyl)-2-phenoxy)-1,3-propylzirconium (IV) dibenzyl, bis((2-oxoyl-3-(dibenzo-1H-pyrrole-1-yl)phenyl)-2-phenoxy)-1,4-n-butylzirconium (IV) dimethyl, bis((2-oxoyl-3-(dibenzo-1H-pyrrole-1-yl)phenyl)-2-phenoxy)-1,4-n-butylzirconium (IV) dibenzyl, bis((2-oxoyl-3-(3,6-bis(1,1-dimethylethyl)-9H-carbazolyl)phenyl)-2-phenoxy)-1,3-propylzirconium (IV) dimethyl, bis((2-oxoyl-3-(3,6-bis(1,1-dimethylethyl)-9H-carbazolyl)phenyl)-2-phenoxy)-1,3-propylzirconium (IV) dibenzyl, bis((2-oxoyl-3-(3,6-bis(1,1-dimethylethyl)-9H-carbazolyl)phenyl)-2-phenoxy)-1,4-n-butylzirconium (IV) dimethyl, bis((2-oxoyl-3-(3,6-bis(1,1-dimethylethyl)-9H-carbazolyl)phenyl)-2-phenoxy)-1,4-n-butylzirconium (IV) dibenzyl; preferably bis((2-oxoyl-3-(dibenzo-1H-pyrrole-1-yl)-5-(methyl)phenyl)-2-phenoxy)-2,4-pentanediylzirconium (IV) dimethyl, bis((2-oxoyl-3-(dibenzo-1H-pyrrole-1-yl)-5-(methyl)phenyl)-2-phenoxy)-2,4-pentanediylzirconium (IV) dichloride; and more preferably bis((2-oxoyl-3-(dibenzo-1H-pyrrole-1-yl)-5-(methyl)phenyl)-2-phenoxy)-2,4-pentanediylhafnium (IV) dimethyl, bis((2-oxoyl-3-(dibenzo-1H-pyrrole-1-yl)-5-(methyl)phenyl)-2-phenoxy)-2,4-pentanediylhafnium (IV) dichloride

Other suitable metal catalyst precursors can also be the trivalent transition metal as those described in WO 9319104 or in WO 9613529, for example [(C₅H₄)CH₂CH₂N(Me)₂]MCl₂, [(C₅Me₄)CH₂CH₂N(Me)₂]MCl₂, [(C₅H₄)CH₂CH₂N(i-Pr)₂]MCl₂, [(C₅Me₄)CH₂CH₂N(i-Pr)₂]MCl₂, [(C₅H₄)CH₂CH₂N(n-Bu)₂]MCl₂, [(C₅Me₄)CH₂CH₂N(n-Bu)₂]MCl₂, [(C₉H₆)CH₂CH₂N(Me)₂]MCl₂, [(CeH₆)CH₂CH₂N(i-Pr)₂]MCl₂, [(C₅Me₄)C₉H₆N]MCl₂, [(C₅Me₃(SiMe₃))C₉H₆N]MCl₂, [(C₉H₆)C₅H₆N]MCl₂, [(C₅Me₄)CH₂C₅H₄N]MCl₂ or [(C₅H₆)CH₂C₅H₄N]MCl₂, where M is titanium or chromium. Examples of catalyst precursors are (C₅Me₄)CH₂CH₂N(Me)₂]TiCl₂, [C₆H₅C(NSiMe₃)₂]TiCl₂(THF)₂ and [C₆H₅C(NSiMe₃)CH₂CH₂N(CH₃)₂]TiCl₂(THF).

Other non-limiting examples of metal catalyst precursors that would be suitable according to the present invention are: (pyrrolidinyl)ethyl-tetramethylcyclopentadienyl titanium dichloride, (N,N-dimethylamino)ethyl-fluorenyl titanium dichloride, (bis(1-methyl-ethyl)phosphino)ethyl-tetramethylcyclopentadienyl titanium dichloride, (bis(2-methyl-propyl)phosphino)ethyl-tetramethylcyclopentadienyl titanium dichloride, (diphenylphosphino)ethyl-tetramethylcyclopentadienyl titanium dichloride, (diphenylphosphino)methyldimethylsilyl-tetramethylcyclopentadienyl titanium dichloride.

According to the invention, other suitable catalyst precursors can be for example {N′,N″-bis[2,6-di(1-methylethyl)phenyl]-N,N-diethylguanidinato}metal dichloride, {N′,N″bis[2,6-di(1-methylethyl)phenyl]-N-methyl-N-cyclohexylguanidinato}metal dichloride, {N′,N″-bis[2,6-di(1-methylethyl)phenyl]-N,N-pentamethyleneguanidinato}metal dichloride, {N′,N″-bis[2,6-di(methyl)phenyl]-sec-butyl-aminidinato}metal dichloride, {N,N′-bis(trimethylsilyl)benzamidinato}metal dichloride, {N-trimethylsilyl,N′—(N″,N″-dimethylaminomethyl)benzamidinato}metal dichloride and their THF or other Lewis base adducts, where metal is titanium or chromium,

Other suitable metal catalyst precursors can also be hafnium or zirconium or titanium complex supported by a dianionic tri- and/or tetra-dentate ligand, for example: 2′-((3-(9H-carbazol-9-yl)-2-olato-5-methylphenyl)(3-methoxypropyl)amino)-3-(9H-carbazol-9-yl)-5-methyl-[1,1-biphenyl]-2-olato]dimethyl hafnium; 2′-((3-(9H-carbazol-9-yl)-2-olato-5-methylphenyl)(3-methoxypropyl)amino)-3-(9H-carbazol-9-yl)-5-methyl-[1,1′-biphenyl]-2-olato]dimethyl zirconium; [2′-((3-(9H-carbazol-9-yl)-2-olato-5-methylphenyl)(3-methoxypropyl)amino)-3-(adamantan-1-yl)-5-methyl-[1,1′-biphenyl]-2-olato]dimethyl hafnium; [2′-((3-(9H-carbazol-9-yl)-2-olato-5-methylphenyl)(3-methoxypropyl)amino)-3-(adamantan-1-yl)-5-methyl-[1,1′-biphenyl]-2-olato]dimethyl zirconium; [2′-((3-(adamantan-1-yl)-2-olato-5-methylphenyl)(3-methoxypropyl)amino)-3-(9H-carbazol-9-yl)-5-methyl-[1,1′-biphenyl]-2-olato]dimethyl zirconium; [2′-((3-(adamantan-1-yl)-2-olato-5-methylphenyl)(3-methoxypropyl)amino)-3-(9H-carbazol-9-yl)-5-methyl-[1,1-biphenyl]-2-olato]dimethyl hafnium; [2′-((3-(adamantan-1-yl)-2-olato-5-methylphenyl)(2-methoxyethyl)amino)-3-(9H-carbazol-9-yl)-5-methyl-[1,1′-biphenyl]-2-olato]dimethyl zirconium: [2′-((3-(adamantan-1-yl)-2-olato-5-methylphenyl)(2-methoxyethyl)amino)-3-(9H-carbazol-9-yl)-5-methyl-[1,1′-biphenyl]-2-olato]dimethyl hafnium; [2′-((3-((3r,5r,7r)-adamantan-1-yl)-2-hydroxy-5-methylphenyl)(3-methoxypropyl)amino)-3-(tert-butyl)-5-methyl-[1,1′-biphenyl]-2-olato]dibenzyl zirconium; [2′-((3-((3r,5r,7r)-adamantan-1-yl)-2-hydroxy-5-methylphenyl)(3-methoxypropyl)amino)-3-(tert-butyl)-5-methyl-[1,1′-biphenyl]-2-olato]dibenzyl zirconium; [3-(tert-butyl)-2′-((3-(tert-butyl)-2-hydroxy-5-methylphenyl)(3-methoxypropyl)amino)-5-methyl-[1,1′-biphenyl]-2-olato]dibenzyl zirconium; [3-(tert-butyl)-2′-((3-(tert-butyl)-2-hydroxy-5-methylphenyl)(3-methoxypropyl)amino)-5-methyl-[1,1′-biphenyl]-2-olato]dibenzyl hafnium; [3-(tert-butyl)-2′-((3-(tert-butyl)-2-hydroxy-5-methylphenyl)(3-methoxypropyl)amino)-5-methyl-[1,1′-biphenyl]-2-olato]dimethyl hafnium; [3-(tert-butyl)-2′-((3-(tert-butyl)-2-hydroxy-5-methylphenyl)(3-methoxypropyl)amino)-5-methyl-[1,1′-biphenyl]-2-olato]dimethyl zirconium; [3-(tert-butyl)-2′-((3-methoxypropyl)(5-methyl-2-(p-tolylamino)phenyl)amino)-5-methyl-[1,1′-biphenyl]-2-olato]dimethyl hafnium; [3-(tert-butyl)-2′-((3-methoxypropyl)(5-methyl-2-(p-tolylamino)phenyl)amino)-5-methyl-[1,1′-biphenyl]-2-olato]dimethyl zirconium; [3-(tert-butyl)-2′-((2-methoxyethyl)(2-((4-methoxyphenyl)amino)-5-methylphenyl)amino)-5-methyl-[1,1′-biphenyl]-2-olato]dimethyl hafnium; [3-(tert-butyl)-2′-((2-methoxyethyl)(2-((4-methoxyphenyl)amino)-5-methylphenyl)amino)-5-methyl-[1,1′-biphenyl]-2-olato]dimethyl zirconium; [3-(tert-butyl)-2′-((2-methoxyethyl)(5-methyl-2-(p-tolylamino)phenyl)amino)-5-methyl-[1,1′-biphenyl]-2-olato]dimethyl hafnium; [3-(tert-butyl)-2′-((2-methoxyethyl)(5-methyl-2-(p-tolylamino)phenyl)amino)-5-methyl-[1,1′-biphenyl]-2-olato]dimethyl zirconium; [3-(tert-butyl)-2′-((2-methoxyethyl)(5-isopropyl-2-(p-tolylamino)phenyl)amino)-5-methyl-[1,1′-biphenyl]-2-olato]dimethyl hafnium; [3-(tert-butyl)-2′-((2-methoxyethyl)(5-isopropyl-2-(p-tolylamino)phenyl)amino)-5-methyl-[1,1′-biphenyl]-2-olato]dimethyl zirconium; [3-(tert-butyl)-2′-((3-(tert-butyl)-2-hydroxy-5-methylphenyl)(3-methoxypropyl)amino)-5-methyl-[1,1′-biphenyl]-2-olato]dimethyl hafnium; [3-(tert-butyl)-2′-((3-(tert-butyl)-2-hydroxy-5-methylphenyl)(3-methoxypropyl)amino)-5-methyl-[1,1′-biphenyl]-2-olato]dimethyl zirconium; [3-(tert-butyl)-2′-((3-(tert-butyl)-2-hydroxy-5-methylphenyl)(3-methoxypropyl)amino)-5-methyl-[1,1′-biphenyl]-2-olato]dichloro titanium; [3-(tert-butyl)-2′-((3-(tert-butyl)-2-hydroxy-5-methylphenyl)(2-methoxyethyl)amino)-5-methyl-[1,1′-biphenyl]-2-olato]monochloro dimethylamido titanium; [3-(tert-butyl)-2′-((3-(tert-butyl)-2-hydroxy-5-methylphenyl)(2-methoxyethyl)amino)-5-methyl-[1,1′-biphenyl]-2-olato]dichloro titanium; [3-(tert-butyl)-2′-((3-(tert-butyl)-2-hydroxy-5-methylphenyl)(2-methoxyethyl)amino)-5-methyl-[1,1′-biphenyl]-2-olato]dimethyl zirconium; [3-(tert-butyl)-2′-((3-(tert-butyl)-2-hydroxy-5-methylphenyl)(2-methoxyethyl)amino)-5-methyl-[1,1′-biphenyl]-2-olato]dimethyl hafnium; [2′-((3-(9H-carbazol-9-yl)-2-hydroxy-5-methylphenyl)(2-(dimethylamino)ethyl)amino)-3-(tert-butyl)-5-methyl-[1,1′-biphenyl]-2-olato]dibenzyl hafnium; [2′-((3-(9H-carbazol-9-yl)-2-hydroxy-5-methylphenyl)(2-(dimethylamino)ethyl)amino)-3-(tert-butyl)-5-methyl-[1,1′-biphenyl]-2-olato]dimethyl hafnium; [2′-((3-(9H-carbazol-9-yl)-2-hydroxy-5-methylphenyl)(2-(dimethylamino)ethyl)amino)-3-(tert-butyl)-5-methyl-[1,1′-biphenyl]-2-olato]dimethyl zirconium; [2′-((3-(9H-carbazol-9-yl)-2-hydroxy-5-methylphenyl)(2-methoxyethyl)amino)-3-(tert-butyl)-5-methyl-[1,1′-biphenyl]-2-olato]dibenzyl hafnium; [2′-((3-(9H-carbazol-9-yl)-2-hydroxy-5-methylphenyl)(2-methoxyethyl)amino)-3-(tert-butyl)-5-methyl-[1,1′-biphenyl]-2-olato]dimethyl hafnium; [2′-((3-(9H-carbazol-9-yl)-2-hydroxy-5-methylphenyl)(2-methoxyethyl)amino)-3-(tert-butyl)-5-methyl-[1,1′-biphenyl]-2-olato]dibenzyl zirconium; [2′-((3-(9H-carbazol-9-yl)-2-hydroxy-5-methylphenyl)(2-methoxyethyl)amino)-3-(tert-butyl)-5-methyl-[1,1′-biphenyl]-2-olato]dimethyl zirconium; [2′-((3-(9H-carbazol-9-yl)-2-hydroxy-5-methylphenyl)(2-methoxyethyl)amino)-3-(9H-carbazol-9-yl)-5-methyl-[1,1′-biphenyl]-2-olato]dibenzyl hafnium; [2′-((3-(9H-carbazol-9-yl)-2-hydroxy-5-methylphenyl)(2-methoxyethyl)amino)-3-(9H-carbazol-9-yl)-5-methyl-[1,1′-biphenyl]-2-olato]dimethyl hafnium; [2′-((3-(9H-carbazol-9-yl)-2-hydroxy-5-methylphenyl)(2-methoxyethyl)amino)-3-(9H-carbazol-9-yl)-5-methyl-[1,1′-biphenyl]-2-olato]dibenzyl zirconium; [2′-((3-(9H-carbazol-9-yl)-2-hydroxy-5-methylphenyl)(2-methoxyethyl)amino)-3-(9H-carbazol-9-yl)-5-methyl-[1,1′-biphenyl]-2-olato]dimethyl zirconium; [3-((1s,3s)-adamantan-1-yl)-2′-((3-((3r,5r,7r)-adamantan-1-yl)-2-hydroxy-5-methylphenyl)(2-methoxyethyl)amino)-5-methyl-[1,1′-biphenyl]-2-olato]dimethyl hafnium; [3-((1s,3s)-adamantan-1-yl)-2′-((3-((3r,5r,7r)-adamantan-1-yl)-2-hydroxy-5-methylphenyl)(2-methoxyethyl)amino)-5-methyl-[1,1′-biphenyl]-2-olato]dimethyl zirconium; [6,6′-(((2-methoxyethyl)azanediyl)bis(methylene))bis(2,4-di-tert-butylphenolato) dibenzyl hafnium; [6,6′-(((2-methoxyethyl)azanediyl)bis(methylene))bis(2,4-di-tert-butylphenolato) dibenzyl zirconium; [2-(tert-butyl)-6-((3-methoxypropyl)(2′-(p-tolylamino)-[1,1′-biphenyl]-2-yl)amino)-4-methylphenolato]dimethyl hafnium; [3-(tert-butyl)-2′-((3-(tert-butyl)-2-hydroxy-5-methylphenyl)(3-phenoxypropyl)amino)-5-methyl-[1,1′-biphenyl]-2-olato]dimethyl hafnium; [3-(tert-butyl)-2′-((3-(tert-butyl)-2-hydroxy-5-methoxyphenyl)(3-methoxypropyl)amino)-5-methyl-[1,1′-biphenyl]-2-olato]dimethyl zirconium; [3-(tert-butyl)-2′-((3-(tert-butyl)-2-hydroxy-5-(trifluoromethyl)phenyl)(3-methoxypropyl)amino)-5-methyl-[1,1′-biphenyl]-2-olato]dibenzyl zirconium; [3-(tert-butyl)-2′-((3-(tert-butyl)-2-hydroxy-5-methylphenyl)(3-(phenylthio)propyl)amino)-5-methyl-[1,1′-biphenyl]-2-olato]dimethyl hafnium; →[3-(tert-butyl)-2′-((3-(tert-butyl)-2-hydroxy-5-methylphenyl)(3-(phenylthio)propyl)amino)-5-methyl-[1,1′-biphenyl]-2-olato]dimethyl zirconium; [3-(tert-butyl)-2′-((3-methoxypropyl)(5-methyl-2-(p-tolylamino)phenyl)amino)-5-methyl-[1,1′-biphenyl]-2-olato]dichloro titanium; 3-(tert-butyl)-2′-((2-methoxyethyl)(5-methyl-2-(p-tolylamino)phenyl)amino)-5-methyl-[1,1′-biphenyl]-2-olato]dichloro titanium; [3″,5″-di-tert-butyl-2-((3-(tert-butyl)-2-hydroxy-5-methylphenyl)(3-methoxypropyl)amino)-5′-methyl-[1,1′:3′,1″-terphenyl]-2′-olato]dimethyl hafnium; 3-(tert-butyl)-2′-((3-(tert-butyl)-2-hydroxy-5-methylphenyl)(2-ethoxyethyl)amino)-5-methyl-[1,1′-biphenyl]-2-olato]dichloro titanium; 3-(tert-butyl)-2′-(butyl(3-(tert-butyl)-2-hydroxy-5-methylphenyl)amino)-5-methyl-[1,1′-biphenyl]-2-olato]dibenzyl hafnium; 3-(tert-butyl)-2′-(butyl(3-(tert-butyl)-2-hydroxy-5-methylphenyl)amino)-5-methyl-[1,1′-biphenyl]-2-olato]dibenzyl zirconium; [2″-((3-(tert-butyl)-2-hydroxy-5-methylphenyl)(3-methoxypropyl)amino)-2,4,5′,6-tetramethyl-[1,1′:3′,1″-terphenyl]-2′-olato]dimethyl zirconium; [3-(tert-butyl)-2′-((3-(tert-butyl)-2-hydroxy-5-methylphenyl)(3-(dimethylamino)propyl)amino)-[1,1′-biphenyl]-2-olato]dibenzyl zirconium; [N2-(3-methoxypropyl)-N2-(5-methyl-2-(p-tolylamino)phenyl)-N2′-(p-tolyl)-[1,1′-biphenyl]-2,2′-diamino]dichloro hafnium; [N2-(3-methoxypropyl)-N2-(5-methyl-2-(p-tolylamino)phenyl)-N2′-(p-tolyl)-[1,1′-biphenyl]-2,2′-diamino]dichloro zirconium; [N2-(3-methoxypropyl)-N2-(5-methyl-2-(p-tolylamino)phenyl)-N2′-(p-tolyl)-[1,1′-biphenyl]-2,2′-diamino]dimethyl hafnium; [N2-(3-methoxypropyl)-N2-(5-methyl-2-(p-tolylamino)phenyl)-N2′-(p-tolyl)-[1,1′-biphenyl]-2,2′-diamino]dimethyl zirconium; 3-(tert-butyl)-2′-((3-(tert-butyl)-2-hydroxy-5-methylphenyl)(3-(dimethylamino)propyl)amino)-5-methyl-[1,1′-biphenyl]-2-olato]dichloro titanium; [2′-((3-((3r,5r,7r)-adamantan-1-yl)-2-hydroxy-5-methylphenyl)(3-methoxypropyl)amino)-3-(tert-butyl)-5-methyl-[1,1′-biphenyl]-2-olato]dichloro titanium; [2′-((3-((3r,5r,7r)-adamantan-1-yl)-2-hydroxy-5-methylphenyl)(3-methoxypropyl)amino)-3-(tert-butyl)-5-methyl-[1,1′-biphenyl]-2-olato]dimethyl hafnium; [3-(tert-butyl)-2′-((3-(tert-butyl)-2-hydroxy-5-methylphenyl)(4-methoxybutyl)amino)-5-methyl-[1,1′-biphenyl]-2-olato]dimethyl hafnium; [3-(tert-butyl)-2′-((3-(tert-butyl)-2-hydroxy-5-methylphenyl)(4-methoxybutyl)amino)-5-methyl-[1,1′-biphenyl]-2-olato]dimethyl zirconium; [3-(tert-butyl)-2′-((3-(tert-butyl)-2-hydroxy-5-methylphenyl)(3-ethoxypropyl)amino)-5-methyl-[1,1′-biphenyl]-2-olato]dimethyl zirconium; [3-(tert-butyl)-2′-((3-(tert-butyl)-2-hydroxy-5-methylphenyl)(3-ethoxypropyl)amino)-5-methyl-[1,1′-biphenyl]-2-olato]dichloro titanium; [2″-((3-(tert-butyl)-2-hydroxy-5-methylphenyl)(3-methoxypropyl)amino)-2,4,5′,6-tetramethyl-[1,1′:3′,1″-terphenyl]-2′-olato]dimethyl hafnium; [3-((1S,3s)-adamantan-1-yl)-2′-((3-(tert-butyl)-2-hydroxy-5-methylphenyl)(3-methoxypropyl)amino)-5-methyl-[1,1′-biphenyl]-2-olato]dimethyl hafnium; [3-((1S,3s)-adamantan-1-yl)-2′-((3-(tert-butyl)-2-hydroxy-5-methylphenyl)(3-methoxypropyl)amino)-5-methyl-[1,1′-biphenyl]-2-olato]dimethyl zirconium; [2-(tert-butyl)-6-((2′-(isopropylamino)-5′-methyl-[1,1′-biphenyl]-2-yl)(3-methoxypropyl)amino)-4-methylphenolato]dibenzyl hafnium; [2-(tert-butyl)-6-((2′-(isopropylamino)-5′-methyl-[1,1′-biphenyl]-2-yl)(3-methoxypropyl)amino)-4-methylphenolato]dibenzyl zirconium; [2′-((3-(tert-butyl)-2-hydroxy-5-methylphenyl)(3-methoxypropyl)amino)-5-methyl-3-(2-phenylpropan-2-yl)-[1,1′-biphenyl]-2-olato]dimethyl hafnium; [2′-((3-(tert-butyl)-2-hydroxy-5-methylphenyl)(3-methoxypropyl)amino)-5-methyl-3-(2-phenylpropan-2-yl)-[1,1′-biphenyl]-2-olato]dimethyl zirconium; [2′-((3-(tert-butyl)-2-hydroxy-5-methylphenyl)(3-methoxypropyl)amino)-5-methyl-3-(2-phenylpropan-2-yl)-[1,1′-biphenyl]-2-olato]dimethyl zirconium,

Other non-limiting examples of metal catalyst precursors that would be suitable according to the present invention are hafnium or zirconium complexes supported by a tridentate ligand containing dianionic phenolate groups bridged by a neutral N-heterocyclic group, for example: -(3′-((3r,5r,7r)-adamantan-1-yl)-2′-methoxy-5′-methyl-[1,1′-biphenyl]-2-yl)-6-(3′-((1r,3r)-adamantan-2-yl)-2′-methoxy-5′-methyl-[1,1′-biphenyl]-2-yl)pyridine dimethylhafnium, 2-(3′-((3r,5r,7r)-adamantan-1-yl)-2′-methoxy-5′-methyl-[1,1′-biphenyl]-2-yl)-6-(3′-((1r,3r)-adamantan-2-yl)-2′-methoxy-5′-methyl-[1,1′-biphenyl]-2-yl)pyridine dimethylzirconium, 2-(3′-((3r,5r,7r)-adamantan-1-yl)-2′-methoxy-4,5′-dimethyl-[1,1′-biphenyl]-2-yl)-6-(3′-((1r,3r)-adamantan-2-yl)-2′-methoxy-4,5′-dimethyl-[1,1′-biphenyl]-2-yl)pyridine-dimethylhafnium, 2-(3′-((3r,5r,7r)-adamantan-1-yl)-2′-methoxy-4,5′-dimethyl-[1,1′-biphenyl]-2-yl)-6-(3′-((1r,3r)-adamantan-2-yl)-2′-methoxy-4,5′-dimethyl-[1,1′-biphenyl]-2-yl)pyridine dimethylzirconium, 2-(3′-((3r,5r,7r)-adamantan-1-yl)-5′-(tert-butyl)-2′-methoxy-4-methyl-[1,1′-biphenyl]-2-yl)-6-(3′-((1r,3r)-adamantan-2-yl)-5′-(tert-butyl)-2′-methoxy-4-methyl-[1,1′-biphenyl]-2-yl)pyridine dimethylhafnium, 2-(3′-((3r,5r,7r)-adamantan-1-yl)-5′-(tert-butyl)-2′-methoxy-4-methyl-[1,1′-biphenyl]-2-yl)-6-(3′-((1r,3r)-adamantan-2-yl)-5′-(tert-butyl)-2′-methoxy-4-methyl-[1,1′-biphenyl]-2-yl)pyridine dimethylzirconium, 2-(3′-((3r,5r,7r)-adamantan-1-yl)-5′-isopropyl-2′-methoxy-4-methyl-[1,1′-biphenyl]-2-yl)-6-(3′-((1r,3r)-adamantan-2-yl)-5′-isopropyl-2′-methoxy-4-methyl-[1,1′-biphenyl]-2-yl)pyridine dimethylhafnium, 2-(3′-((3r,5r,7r)-adamantan-1-yl)-5′-isopropyl-2′-methoxy-4-methyl-[1,1′-biphenyl]-2-yl)-6-(3′-((1r,3r)-adamantan-2-yl)-5′-isopropyl-2′-methoxy-4-methyl-[1,1′-biphenyl]-2-yl)pyridine dimethylzirconium, 2-(3′-((3r,5r,7r)-adamantan-1-yl)-2′-methoxy-4,5′-dimethyl-[1,1′-biphenyl]-2-yl)-6-(3′-((1 r,3r)-adamantan-2-yl)-2′-methoxy-4,5′-dimethyl-[1,1′-biphenyl]-2-yl)-4-(trifluoromethyl)pyridine dimethylhafnium, 2,6-bis(2′-methoxy-5′-methyl-3′-(2-phenylpropan-2-yl)-[1,1′-biphenyl]-2-yl)pyridine dimethylhafnium, 2,6-bis(2′-methoxy-5′-methyl-3′-(2-phenylpropan-2-yl)-[1,1′-biphenyl]-2-yl)pyridine methylzirconium, 2,6-bis(2′-methoxy-4,5′-dimethyl-3′-(2-phenylpropan-2-yl)-[1,1′-biphenyl]-2-yl)pyridine dimethylhafnium, 2,6-bis(2′-methoxy-4,5′-dimethyl-3′-(2-phenylpropan-2-yl)-[1,1′-biphenyl]-2-yl)pyridine dimethylhafnium, 2,6-bis(3′-(9H-carbazol-9-yl)-2′-methoxy-5′-methyl-[1,1′-biphenyl]-2-yl)pyridine dimethylhafnium, 2,6-bis(3′-(9H-carbazol-9-yl)-2′-methoxy-5′-methyl-[1,1′-biphenyl]-2-yl)pyridine dimethylzirconium, 2,6-bis(3′-(9H-carbazol-9-yl)-2′-methoxy-4,5′-dimethyl-[1,1′-biphenyl]-2-yl)pyridine dimethylhafnium, 2,6-bis(2″,6″-di-tert-butyl-2′-methoxy-4,5′-dimethyl-[1,1′:3′,1″-terphenyl]-2-yl)pyridine dimethylhafnium, 2,6-bis(2″,6″-di-tert-butyl-2′-methoxy-4,5′-dimethyl-[1,1′:3′,1″-terphenyl]-2-yl)pyridine dimethylzirconium.

Other non-limiting examples of metal catalyst precursors that would be suitable according to the present invention are rac-dimethylsilyl bis(2-methyl-4-phenyl-1-indenyl) zirconium dichloride, dimethylsilyl bis(1,3-dimethyl-inden-2-yl)(2,4-diphenyl-inden-1-yl) hafnium dimethyl, dimethylsilyl (1,3-dimethyl-inden-2-yl)(2-phenyl-cyclopenta[a]naphthalen-3-yl) zirconium dichloride.

In addition of one of the above catalyst precursors, the polymerization process to produce the hydroxyl-functionalized propylene-based copolymers may further include:
a co-catalyst selected from the group: MAO, DMAO, MMAO, SMAO or ammonium salts or trityl salts of fluorinated tetraarylborates, preferably MAO, MMAO, and
optionally, a scavenger selected from the group: trimethyl aluminum, triethyl aluminum, triisobutyl aluminum, trihexyl aluminum, trioctyl aluminum and
optionally, a chain transfer agent selected from the group: dihydrogen or AlR¹⁰₃, BR¹⁰₃ or MgR¹⁰₂ or ZnR¹⁰₂, where each R¹⁰ is independently selected from hydrogen or hydrocarbyl, preferably C₁-C₁₀ hydrocarbyl.

Preferably, the hydroxyl-functionalized propylene-based copolymer can be selected from the group comprising: poly(propylene-co-5-hexen-1-ol), poly(propylene-co-10-undecen-1-ol), poly(propylene-co-ethylene-co-5-hexen-1-ol), poly(propylene-co-ethylene-co-10-undecen-1-ol), poly(propylene-co-1-hexene-co-5-hexen-1-ol), poly(propylene-co-1-hexene-co-10-undecen-1-ol), poly(propylene-co-1-octene-co-5-hexen-1-ol), poly(propylene-co-1-octene-co-10-undecen-1-ol) or a mixture of them, more preferably selected from poly(propylene-co-5-hexen-1-ol), poly(propylene-co-ethylene-co-5-hexen-1-ol), poly(propylene-co-1-hexene-co-5-hexen-1-ol), poly(propylene-co-1-octene-co-5-hexen-1-ol).

Preferably the amount of hydroxyl-functionalized propylene-based copolymer, within the modified bitumen composition is between 1.25 and 5 wt %, preferably between 1.25 and 2.5 wt %, preferably between 2 and 3 wt %, preferably between 2.3 and 2.7 wt %.

In a preferred embodiment, the mineral adhesion promoter could further comprise in addition of the hydroxyl-functionalized propylene-based copolymer, an aluminum-containing residue. As inventors surprisingly discovered, the interaction of the aluminum-containing residue with the copolymers structure can increase stiffness, compatibility and softening point of the polymer modified bitumen.

The amount of aluminum-containing residue comprising an elemental aluminum content shall not be above 1.5 wt % of the hydroxyl-functionalized propylene-based copolymer within the asphalt composition, as its presence within the asphalt composition decreases the adhesion to mineral aggregates. Preferably, the amount of aluminum-containing residue comprising an elemental aluminum content is between 0.05 to 1.5 wt %, more preferably 0.05 to 1.2 wt %, even more preferably 0.1 and 1.0 wt %, even preferably from 0.8 to 1.0 wt %, even more preferably 0.2 and 0.4 wt %, even more preferably 0.20 to 0.35 wt %, even more preferably 0.26 to 0.32 wt % or preferably between 0.05 to 0.3 wt % of the hydroxyl-functionalized propylene-based copolymer.

The aluminum-containing residue comprising an elemental aluminum content may be for example an aluminum oxide and/or an aluminum hydroxide and/or an aluminum alkoxide or a mixture of them, preferably according to the formula: Al(O)ₓ(OH)_{y}(OR)_{z} where x=0-1.5, y=0-3, z=0-3 and (2 x+y+z)=3 and wherein R is an aliphatic hydrocarbyl group, preferably from C₁ to C₆, preferably Me, Et, nPr, iPr, nBu, iBu, or tBu, even more preferably isopropyl.

The introduction of the aluminum-containing residue can be achieved by incorporation of organoaluminum compounds, more preferably aluminum alkyls, at the commencement stage of copolymers synthesis. These aluminum alkyls can react with the hydroxyl functionality of the functional comonomer. Aluminum alkyl species are known in the art, in particular in WO2022/106689 as functional comonomer passivating agents, which prevent poisoning and deactivation of the catalyst's oxophilic metal center during the polymerization. Hydrolysis of the aluminum alkyl-passivated hydroxyl-functionalized propylene-based copolymers affords hydroxyl-functionalized propylene-based copolymers having finely dispersed aluminum-containing residues.

Preferably, aluminum alkyl precursors providing, after hydrolysis, crosslinking of hydroxyl-functionalized comonomer segments within propylene-based copolymers architecture in the form of aluminum-containing residue nodes can be selected from the group comprising: triisobutylaluminum (TiBA), triethylaluminum (TEA), methylaluminumoxane (MAO), trimethyl aluminum (TMA), trihexylaluminum, trioctylaluminum or a mixture thereof.

In some embodiment, the aluminum-containing residue is the residue of the passivating agent used to passivate the hydroxyl functional groups of one of the monomers during the synthesis of the hydroxyl functionalized propylene-based copolymer that is obtained after reacting with water and/or alcohol.

In a more preferred embodiment, the “amine-free” asphalt composition according to the invention comprises:
a. Mineral aggregates in a quantity from 95 to 99 wt % of the asphalt composition
b. A modified bitumen composition in a quantity from 1.0 to 10 wt % of the asphalt composition which comprise
   i. A neat bitumen in a quantity from 95 to 98.75 wt % of the modified bitumen composition, and
   ii. A hydroxyl-functionalized propylene-based copolymer preferably selected from poly(propylene-co-5-hexen-1-ol), poly(propylene-co-ethylene-co-5-hexen-1-ol), poly(propylene-co-1-hexene-co-5-hexen-1-ol), poly(propylene-co-1-octene-co-5-hexen-1-ol), in a quantity from 1.25 to 5.0 wt % of the modified bitumen composition, and preferably having a hydroxyl-functionalized olefin comonomer content between 0.1 and 0.6 mol %, more preferably 0.2 to 0.5 mol %, and
   iii. An aluminum-containing residue comprising an elemental aluminum content from a quantity of 0.05 to 1.5 wt % of the hydroxyl-functionalized propylene-based copolymer within the modified bitumen composition

In an even more preferred embodiment, the “amine-free” asphalt composition according to the invention comprises:
a. Mineral aggregates in a quantity from 93 to 95 wt % of the asphalt composition
b. A modified bitumen composition in a quantity from 5.0 to 7.0 wt % of the asphalt composition
   i. A neat bitumen in a quantity from 97.5 to 98.75 wt % of the modified bitumen composition, and
   ii. A hydroxyl-functionalized propylene-based copolymer, more preferably poly(propylene-co-1-hexene-co-5-hexen-1-ol), in a quantity from 1.25 to 2.5 wt %, more preferably 2.3 to 2.5 wt % of the modified bitumen composition, and preferably having a hydroxyl-functionalized olefin comonomer content between 0.1 and 0.6 mol %, more preferably 0.2 to 0.5 mol %, and
   iii. An aluminum-containing residue comprising an elemental aluminum content from a quantity of 0.05 to 1.5 wt %, preferably from 0.8 to 1.0 wt % of the hydroxyl-functionalized propylene-based copolymer within the asphalt composition

An embodiment of the invention is an asphalt composition having this specific composition:
Mineral aggregates in a quantity of 93 to 95 wt %, preferably 93.5 to 94.5 wt % of the asphalt composition
A modified bitumen composition in a quantity 5 to 7 wt %, preferably 5.5 to 6.5 wt % of the asphalt composition
   a. A neat bitumen in a quantity of 97 to 98 wt %, preferably 97.3 to 97.7 wt % modified bitumen
   b. A hydroxyl-functionalized propylene-based copolymer poly(propylene-co-1-hexene-co-5-hexen-1-ol, preferably having a hydroxyl-functionalized olefin comonomer content between 0.1 to 0.4, preferably between 0.2 to 0.3 mol % in quantity of 2 to 3 wt %, preferably 2.3 to 2.7 wt % of modified bitumen and which including an aluminum-containing residue comprising an elemental aluminum content, preferably in a quantity of 0.20 to 0.35 wt %, preferably 0.26 to 0.32 wt % of the total hydroxyl-functionalized propylene-based copolymer

An embodiment of the invention is a modified bitumen having this specific composition: A neat bitumen in a quantity of 97 to 98 wt %, preferably 97.3 to 97.7 wt % modified bitumen, a hydroxyl-functionalized propylene-based copolymer poly(propylene-co-1-hexene-co-5-hexen-1-ol, preferably having a hydroxyl-functionalized olefin comonomer content between 0.1 to 0.4 mol %, preferably between 0.2 to 0.3 mol %, in a quantity of 2 to 3 wt %, preferably 2.3 to 2.7 wt % of modified bitumen and which includes an aluminum-containing residue comprising an elemental aluminum content, preferably in a quantity of 0.20 to 0.35 wt %, preferably 0.26 to 0.32 wt % of the total hydroxyl-functionalized propylene-based copolymer.

Another aspect of the invention is a mineral adhesion promoter comprising:
a. A hydroxyl-functionalized propylene-based copolymer preferably selected from poly(propylene-co-5-hexen-1-ol), poly(propylene-co-ethylene-co-5-hexen-1-ol), poly(propylene-co-1-hexene-co-5-hexen-1-ol), poly(propylene-co-1-octene-co-5-hexen-1-ol) and preferably having a a hydroxyl-functionalized olefin comonomer content between 0.1 and 0.6 mol %, more preferably 0.2 to 0.5 mol %,
b. An aluminum-containing residue comprising an elemental aluminum content from a quantity of 0.05 to 1.5 wt % of the hydroxyl-functionalized propylene-based copolymer,

In an embodiment the mineral adhesion promoter comprises:
a. A hydroxyl-functionalized propylene-based copolymer, more preferably poly(propylene-co-1-hexene-co-5-hexen-1-ol) and preferably having a hydroxyl-functionalized olefin comonomer content between 0.1 and 0.6 mol %, more preferably 0.2 to 0.5 mol %,
b. An aluminum-containing residue comprising an elemental aluminum content from a quantity of 0.05 to 0.3 wt % of the hydroxyl-functionalized propylene-based copolymer within the asphalt composition.

Another embodiment of the invention is a promoter having this specific composition:
a. A hydroxyl-functionalized propylene-based copolymer poly(propylene-co-1-hexene-co-5-hexen-1-ol), preferably having a hydroxyl-functionalized olefin comonomer content between 0.2 or 0.3 mol %,
b. An aluminum-containing residue comprising an elemental aluminum content in a quantity of 0.20 to 0.35 wt %, preferably 0.26 to 0.32 wt % of the hydroxyl-functionalized propylene-based copolymer.

### EXAMPLES

Typical Preparation Procedure of Isotactic poly(propylene-co-1-hexene) (Table 1, PO):

Experiments were carried out using a stainless steel BÜCHI reactor (2 L) filled with pentamethylheptane (PMH) solvent (1 L) using a stirring speed of 600 rpm. The reactor was first heated to 40° C., followed by the addition of TiBA (2 mL, 1.0 M solution in toluene, 2 mmol). The reactor was loaded at 40° C. with gaseous propylene (100 g) and 1-hexene (30 mL, neat, 240 mmol) and was heated up to the desired polymerization temperature of 130° C. resulting in a partial propylene pressure of about 15 bar. Once the set temperature was reached, the polymerization reaction was initiated by the injection of the pre-activated catalyst precursor bis((2-oxoyl-3-(dibenzo-1H-pyrrole-1-yl)-5-(methyl)phenyl)-2-phenoxy)-2,4-pentanediylhafnium (IV) dimethyl [CAS 958665-18-4](Hf—O4, 0.25 mg, 0.25 μmol) in MAO (2.5 mL, 30 wt % solution in toluene, 11.3 mmol) in toluene (5 mL). The reaction was stopped by pouring the polymer solution into an Erlenmeyer flask containing water and isopropanol (50% v/v, 500 mL) and Irganox 1010 (5 mL, 1.0 M in acetone, 0.5 mmol). The resulting suspension was stirred for 4 h, filtered, washed with demineralized water and iPrOH solution (50% v/v, 2×500 mL) and dried at 80° C. in a vacuum oven, prior the addition of Irganox 1010 as antioxidant (5 mL, 1.0 M in acetone, 0.5 mmol). The poly(propylene-co-1-hexene) was obtained as an elastic transparent material.

Typical Preparation Procedure of Isotactic poly(propylene-co-1-hexene-co-5-hexen-1-ol) (Table 1, FPO1-3):

The polymerization experiment was carried out using a stainless steel BÜCHI reactor (2 L) using a stirring speed of 600 rpm. Catalyst and co-monomer solutions were prepared in a glove box under an inert dry nitrogen atmosphere. The reactor was first filled with heptane solvent (1 L) and heated to 40° C. followed by the addition of TEA (2 mL, 1.0 M solution in toluene, 2 mmol), 1-hexene (30 mL, neat, 240 mmol), and triethylaluminum (TEA)-passivated 5-hexen-1-ol (1.0 M solution in toluene, TEA:5-hexen-1-ol (mol ratio)=1, 10 mL). The reactor was pressurized at 40° C. with gaseous propylene (100 g) and the reactor was heated to the desired polymerization temperature of 130° C. resulting in a partial propylene pressure of about 15 bar. Once the set temperature was reached, the polymerization reaction was initiated by the injection of the pre-activated catalyst precursor bis((2-oxoyl-3-(dibenzo-1H-pyrrole-1-yl)-5-(methyl)phenyl)-2-phenoxy)-2,4-pentanediylhafnium (IV) dimethyl [CAS 958665-18-4](Hf—O4, 2 mg, 2 μmol) in MAO (2.5 mL, 30 wt % solution in toluene, 11.2 mmol). The reaction was stopped by pouring the polymer solution into a flask containing demineralized water and iPrOH solution (50% v/v, 1 L) and Irganox 1010 (2 mL, 1.0 M in acetone, 2 mmol). The resulting suspension was filtered and dried at 60° C. in a vacuum oven, prior the addition of Irganox 1010 as an antioxidant (5 mL, 1.0 M in acetone, 0.5 mmol). The poly(propylene-co-1-hexene-co-5-hexen-1-ol) was obtained as an elastic transparent material.

Procedure of the Deashing of Isotactic poly(propylene-co-1-hexene-co-5-hexen-1-ol) (Table 1, FPO1(d), FPO2(d):

The copolymers obtained from the solution process may be deashed in order to remove aluminum-containing residue present as residue from the polymerization/precipitation process described above. The terpolymer (10 g) was dispersed in a mixture of toluene (400 mL) with concentrated HCl (10 mL, 37 wt % solution in water, 0.12 mol) and heated under reflux until the copolymer dissolved. Once the polymer was properly dissolved, methanol (250 ml) was added to the hot mixture and the mixture was heated under stirring at 70-80° C. for an additional hour. Then the polymer was precipitated in a cold methanol, filtered and double washed with methanol. The resulting polymer was dried at 80° C. in a vacuum oven for 24 hours.

Typical Preparation Procedure of Atactic poly(propylene-co-1-hexene-co-5-hexen-1-ol) (Table 1, FPO4):

The polymerization reaction of propylene with 5-hexen-1-ol was carried out in a stainless steel autoclave with an internal volume of 2.2 L. The reactor, equipped with a mechanical stirrer interMIG, was operated at 900 rpm. The reactor was first flushed with propylene for at least 30 minutes. Heptane diluent (300 mL), TEA solution (4 mL, 1.0 M solution in toluene, 4 mmol). and TiBA-passivated 5-hexen-1-ol comonomer solution (10 mL, 1.0 M in toluene, 10 mmol, TEA:5-hexen-1-ol (mole ratio)=1) was added followed by the addition of 1-hexene (30 mL, neat, 240 mmol) Heptane was added to bring the total volume to 1 L. The reactor was then heated to 40° C. and the pressure was brought to 9 bar with propylene. Meanwhile a pre-activated [C₅Me₄CH₂CH₂NMe₂]TiCl₂ catalyst solution was prepared in a glovebox by dissolving 5 mg of solid precatalyst in 5 mL toluene (˜16 μmol) and MAO solution (4 mL, 30 wt % solution in toluene, 18 mmol) and the mixture was injected into the reactor applying an over pressure of nitrogen. The reactor temperature was kept at 40±3° C. by cooling with an oil LAUDA system. At the end of the reaction, the mixture was collected via a bottom drain valve in a beaker containing solution of demineralized water and iPrOH (50% v/v, 1 L) and Irganox 1010 (2 mL, 1.0 M in acetone, 2 mmol). The resulting suspension was dried at 60° C. in a vacuum oven, prior to the addition of Irganox 1010 as an antioxidant. The atactic poly(propylene-co-1-hexene-co-5-hexen-1-ol) was obtained as a rubbery transparent material.

Typical Preparation Procedure of Isotactic poly(propylene-co-ethylene-co-5-hexen-1-ol) (Table 1, FPO5):

The polymerization reaction of propylene, ethylene, and TiBA-passivated 5-hexen-1-ol was carried out in a stainless steel autoclave (2.2 L). The mechanical stirrer of the reactor was operated at 900 rpm. The reactor was first flushed with a mixture of ethylene and propylene at set flow for about 30 minutes. Pentamethyl heptane diluent (300 mL), solutions of TEA (4 mL, 1.0 M solution in toluene, 4.0 mmol), TEA-passivated 5-hexen-1-ol (10 mL, 1.0 M in toluene, 10 mmol, TiBA:5-hexen-1-ol (mole ratio)=1) and MAO (0.8 mL, 30 wt % solution in toluene, 3.6 mmol) were added. Pentamethyl heptane was added to bring the total volume to 1 L. The reactor was then heated to 80° C. and the overall pressure was brought to 9 bar with a propylene/ethylene mixture (feed rate wt %=70/30) and kept at this pressure using a set ethylene and propylene flow and a bleeding valve set at 9 bar. A solution of rac-Me₂Si(2-Me-4-Ph-Ind)₂ZrCl₂ catalyst precursor, prepared in a glovebox by dissolving 2 mg of solid precatalyst in 5 mL toluene (˜3.2 μmol), was injected into the reactor applying an over pressure of nitrogen. The reactor temperature was kept at 80±3° C. by cooling with an oil LAUDA system. At the end of the reaction, the mixture was collected via a bottom drain valve in a beaker containing solution of demineralized water and iPrOH (50% v/v, 1 L) and Irganox 1010 (2 mL, 1.0 M in acetone, 2 mmol). The resulting suspension was dried at 60° C. in a vacuum oven, prior to the addition of Irganox 1010 as an antioxidant. The isotactic poly(propylene-co-ethylene-co-5-hexen-1-ol) was obtained as a rubbery transparent material.

Typical Preparation Procedure of Isotactic poly(propylene-co-1-octene-co-5-hexen-1-ol) (Table 1, FPO6):

The polymerization experiment was carried out using a stainless steel BÜCHI reactor (2 L) using a stirring speed of 600 rpm. Catalyst and co-monomer solutions were prepared in a glove box under an inert dry nitrogen atmosphere. The reactor was first filled with heptane solvent (1 L) and heated to 40° C. followed by the addition of TEA (1.0 M solution in toluene, 2 mL), 1-octene (neat 20 mL, 128 mM), and triethylaluminum (TEA)-passivated 5-hexen-1-ol (1.0 M solution in toluene, TEA:5-hexen-1-ol (mol ratio)=1, 10 mL). The reactor was pressurized at 40° C. with gaseous propylene (100 g) and heated to the desired polymerization temperature of 130° C. resulting in a partial propylene pressure of about 15 bar. Once the set temperature was reached, the polymerization reaction was initiated by the injection of the pre-activated catalyst precursor bis((2-oxoyl-3-(dibenzo-1H-pyrrole-1-yl)-5-(methyl)phenyl)-2-phenoxy)-2,4-pentanediylhafnium (IV) dimethyl [CAS 958665-18-4](Hf—O4, 1 μmol) in MAO (10 wt % solution in toluene, 6 mmol). The reaction was stopped by pouring the polymer solution into a flask containing demineralized water/iPrOH (50 wt %, 1 L) and Irganox 1010 (1.0 M, 2 mmol). The resulting suspension was filtered and dried at 60° C. in a vacuum oven, prior the addition of Irganox 1010 as an antioxidant. The poly(propylene-co-1-octene-co-5-hexen-1-ol) was obtained as an elastic transparent material.

### Commercially Available Materials Utilized in the Experiments:

Reference sample for asphalt mixture testing: PMB 45/80-55 MODIT, was supplied by LOTOS Asphalt and used as received. Fatty amine adhesion promoter Teramin 14 (ICSO Chemical Production) was purchased and used as received.

TABLE 1
Molecular characterization and thermal properties of copolymers utilized in the bitumen modification process.

| | | | | | | | | | | | Al |
|---|---|---|---|---|---|---|---|---|---|---|---|
| | | | Mₙ | M_{w} | Ð | Tₘ | ΔHₘ | T_{c} | χ ^{c} | OH | content |
| Entry | Sample name | Structure | [kg/mol] | [kg/mol] | [—] | [° C.] | [J/g] | [° C.] | [%] | [% mol] | [wt %] |
| PO ^{a} | isotactic | C₃-co-C₆ | 30.5 | 94.5 | 3.1 | 83.5 | 37.5 | 50.5 | 18.1 | 0.0 | 0.91 |
| | poly(propylene- | | | | | | | | | | |
| | co-1-hexene) | | | | | | | | | | |
| FPO1^{b} | isotactic | C₃-co-C₆- | 32.5 | 135.2 | 4.4 | 85.5 | 22.1 | 55.6 | 10.7 | 0.2 | 0.99 |
| | poly(propylene- | co-C₆OH | | | | | | | | | |
| | co-1-hexene-co- | | | | | | | | | | |
| | 5-hexen-1-ol | | | | | | | | | | |
| FPO1 | deashed isotactic | C₃-co-C₆- | 31.2 | 133.1 | 4.3 | 82.0 | 26.8 | 40.9 | 12.9 | 0.2 | 0.29 |
| (d)^{b} | poly(propylene- | co-C₆OH | | | | | | | | | |
| | co-1-hexene-co- | | | | | | | | | | |
| | 5-hexen-1-ol | | | | | | | | | | |
| FPO2 | isotactic | C₃-co-C₆- | 28.6 | 140.0 | 4.9 | 73.4 | 7.0 | 44.7 | 3.4 | 0.3 | 0.86 |
| | poly(propylene- | co-C₆OH | | | | | | | | | |
| | co-1-hexene-co- | | | | | | | | | | |
| | 5-hexen-1-ol | | | | | | | | | | |
| FPO2 | isotactic deashed | C₃-co-C₆- | 27.4 | 139.1 | 5.1 | 46.6/ | 12.0 | 16.8 | 5.8 | 0.3 | 0.11 |
| (d) | poly(propylene- | co-C₆OH | | | | 74.1^{d} | | | | | |
| | co-1-hexene-co- | | | | | | | | | | |
| | 5-hexen-1-ol | | | | | | | | | | |
| FPO3 | isotactic | C₃-co-C₆- | 35.8 | 153.4 | 4.3 | 109.1 | 27.1 | 61.2 | 13.1 | 0.2 | 0.89 |
| | poly(propylene- | co-C₆OH | | | | | | | | | |
| | co-1-hexene-co- | | | | | | | | | | |
| | 5-hexen-1-ol | | | | | | | | | | |
| FPO4 | atactic | C₃-co-C₆- | 28.9 | 153.8 | 5.3 | atactic | atactic | atactic | 0.0 | 0.3 | 1.12 |
| | poly(propylene- | co-C₆OH | | | | | | | | | |
| | co-1-hexene-co- | | | | | | | | | | |
| | 5-hexen-1-ol | | | | | | | | | | |
| FPO5 | isotactic | C₃-co-C₂- | 27.9 | 142.0 | 5.1 | 71.3 | 5.8 | 27.8 | 2.8 | 0.2 | 0.81 |
| | poly(propylene- | co-C₆OH | | | | | | | | | |
| | co-ethylene-co- | | | | | | | | | | |
| | 5-hexen-1-ol | | | | | | | | | | |
| FPO6 | isotactic | C₃-co-C₈- | 33.6 | 145.0 | 4.3 | 89.5 | 19.6 | 43.6 | 9.5 | 0.2 | 0.92 |
| | poly(propylene- | co-C₆OH | | | | | | | | | |
| | co-1-octene-co- | | | | | | | | | | |
| | 5-hexen-1-ol | | | | | | | | | | |

^{a} used as a diluter in the blends preparation
^{b}sample applied as a binder's modifier for further asphalt mixture production
^{c} χ was calculated assuming the heat of fusion of 100%-crystalline iPP of 207 J/g
^{d}bimodal distribution

TABLE 2
Properties of a neat bitumen and Polymer Modified Bitumen (PMB) samples.

| | | | | | | | | | | | | | | | Boiling | |
|---|---|---|---|---|---|---|---|---|---|---|---|---|---|---|---|---|
| | | | | | | | | | | | | | | | water test | |
| | | | | | | | | | | | | | | | results | |
| | | | | | | | | | | | | | | | PN-84/B- | |
| | | | | | | | | | | | | | | | 06714/22 | |
| | | | | | | | | | | | | | QNM-AFM | | Aggregates | |
| | | | | | | | | | | | | | results | | surface | |
| Composition | | | | | | | | | | | | | DMT | Adhe- | coverage | |
| | | Modi- | | Basic properties | | | Hot-storage stability test results | | | | | | mod- | sion | | lime- |
| | Type of | fier | Bitumen | η₁₈₀ | P | SP | Pₜₒₚ | P_{bot} | Δ P | SPₜₒₚ | SP_{.bot} | ΔSP | ulus | force | granite | stone |
| Entry | modifier | [wt %] | [wt %] | [Pa · s] | [dmm] | [° C.] | [dmm] | [dmm] | [dmm] | [° C.] | [° C.] | [° C.] | [GPa] | [nN] | [%] | |
| CE1 | Neat | 0.00% | 100% | 0.040 | 90 | 44.2 | 82 | 82 | 0 | 46.1 | 46.0 | 0.1 | 2.5 | 35 | 60 | 45 |
| | bitumen | | | | | | | | | | | | | | | |
| | 70/100 | | | | | | | | | | | | | | | |
| CE2 | Neat | 0.00% | 99.70% | 0.035 | 91 | 44.0 | 83 | 83 | 0 | 46.3 | 46.2 | 0.1 | 2.3 | 55 | 95 | 60 |
| | bitumen | | | | | | | | | | | | | | | |
| | Teramin | 0.30% | | | | | | | | | | | | | | |
| | 14 | | | | | | | | | | | | | | | |
| CE3 | PO | 2.50% | 97.50% | 0.040 | 60 | 51.5 | 45 | 75 | 30 | 65.3 | 48.3 | 16.5 | 2.2 | 37 | 60 | 45 |
| EX1 | FPO1 | 2.50% | 97.50% | 0.048 | 74 | 48.9 | 60 | 62 | 2 | 47.2 | 47.2 | 0.0 | 1.75 | 52 | 80 | 60 |
| EX2^{a} | FPO1(d) | 2.50% | 97.50% | 0.056 | 78 | 46.8 | 66 | 75 | 9 | 47.4 | 48.8 | 1.4 | 1.75 | 57 | 95 | 85 |
| EX3 | FPO2 | 2.50% | 97.50% | 0.042 | 72 | 48.5 | 78 | 79 | 1 | 46.3 | 46.5 | 0.2 | 1.60 | 57 | 99 | 80 |
| EX4 | FPO2(d) | 2.50% | 97.50% | 0.045 | 73 | 47.6 | 70 | 74 | 4 | 46.5 | 46.0 | 0.5 | 1.55 | 61 | 99 | 85 |
| EX5 | FPO3 | 2.50% | 97.50% | 0.055 | 64 | 49.7 | 53 | 67 | 14 | 54.7 | 48.2 | 6.5 | 1.95 | 48 | 70 | 55 |
| EX6 | FPO4 | 2.50% | 97.50% | 0.070 | 78 | 48.0 | 70 | 68 | 2 | 49.3 | 48.9 | 0.4 | 1.30 | 61 | 99 | 90 |
| EX7 | FPO5 | 2.50% | 97.50% | 0.060 | 70 | 49.0 | 63 | 65 | 2 | 49.9 | 49.7 | 0.2 | 1.35 | 55 | 85 | 65 |
| EX8 | FPO6 | 2.50% | 97.50% | 0.060 | 76 | 48.0 | 72 | 68 | 4 | 49.1 | 48.2 | 0.9 | 1.65 | 55 | 80 | 65 |

^{a}applied as a binder for asphalt mixture production
η₁₈₀—dynamic viscosity at 180° C.
P—average penetration value
P, P_{top/bot}, ΔP—average penetration value after storage stability test and the corresponding difference, respectively
S—average softening point
S, S_{top/bot}, ΔS—average softening point after storage stability test and the corresponding difference, respectively

TABLE 3
Properties of asphalt mixtures comprising selected binders.

| | | | Type of Polymer Modified | | |
|---|---|---|---|---|---|
| | | | Bitumen + 93.7 wt % mineral | | |
| | | CE1: | CE2 | | |
| | | Neat | PMB 45/80- | EX1 | |
| | Test | bitumen | 55 + Teramin | FPO1(d) | Required values |
| Property | standards | 70/100 | 14 (0.3 wt %) | (2.5 wt %) | acc. standards |
| Degree of binder | EN 12697- | 50 | 90 | 80 | >=80 |
| coverage on granite | 11 | | | | |
| upon 6 h | (method A) | | | | |
| [%] | | | | | |
| Degree of binder | EN 12697- | 70 | 95 | 84 | >=80 |
| coverage on | 11 | | | | |
| limestone upon 6 h | (method A) | | | | |
| [%] | | | | | |
| Indirect tensile | EN 12697- | ND | 97 | 95 | >90 |
| strength ratio | 12A | | | | |
| ITSR [%] | | | | | |
| Wheel tracking slope | EN 12697- | ND | 0.05 | 0.09 | <0.10 |
| WTS_{AIR} | 22 | | | | |
| upon 10³ cycles | | | | | |
| [mm/10³ cycles] | | | | | |

### Results

From Table 2 all experiment where able to be process into an asphalt mixture. However, EX5 did not fulfil the requirement for Δsoftening point (ΔSP)<5 according to EN 13399, due to a Tm above 100° C.

Furthermore, it can be seen from Table 3, that the addition of the hydroxyl-functionalized propylene-based copolymer with limited amount of an aluminum-containing residue into the asphalt composition when compare to the neat bitumen CE1:
Increase the degree of binder coverage on granite upon 6 h testing and ITSR value, which is beneficial for improving the anti-stripping and moisture resistance of the mixture preventing occurrence of raveling and low-temperature cracks improving the lifespan of a pavement.
Decrease WTS_{AIR} value upon 10³ cycles, which is beneficial for improving the resistance to permanent deformations of a pavement
   When it is compared to the modified bitumen with Teramin CE2, the performance are equivalent but without the toxicity regard to the environment.

### Typical Procedure for Bitumen Modification.

The modification of bitumen was carried out at 180° C. using Ultra-Turaxx T50 basic homogenizer (IKA Company) equipped with S50N-G45G dispersing tool (IKA Company), working at the speed range 4000-6000 rpm. Usually the hot bitumen was mixed with the polymer modifier for 120 minutes.

### Typical Procedure for Penetration Analysis.

Penetration tests were performed according to the European Standard 1426. In this method, a needle with specified dimension and weight is penetrating the asphalt sample, under a 100 g load for 5 seconds at 25° C. The penetration value was expressed in decimillimeters as a vertical distance penetrated by needle into asphalt. The penetration value is the average from three individual measurements.

### Typical Procedure for Softening Point Analysis.

Softening point tests were performed with Ring & Ball apparatus according to European Standard 1427. In this method two metal rings filled with asphalt were heated at a controlled rate 5° C./min in a water bath while each supports a steel ball. The softening point temperature was determined as a temperature at which steel balls coated with asphalt fall through a height of 25 mm. The reported softening point value was an average of the temperatures determined for each ball.

### Typical Procedure for Hot Storage Stability Analysis.

Hot storage stability tests were performed according to the European Standard 13399. In this method, two sealed aluminum tubes filled with asphalt were vertically placed in the oven at 180° C. for 72 h. In the next step, the tubes with asphalt were cooled down and frozen. Then the aluminum cover was removed and asphalt and bitumen are divided into 3 sections: top, middle and bottom, respectively. Then the top and bottom sections were molten separately and used for penetration and softening point analysis.

### AFM HA-QNM Experimental.

Samples were also characterized by HA-QNM mode with a frequency of 0.5 Hz using an AFM tip with a spring constant of 5 N/m (TAP-150-30, No. 3 k=5 N/m) at ambient conditions. With this special tip all the information of the tip needed for the QNM mode can be transferred immediately to the AFM operation program by a click with a bar-reader. Therefore, no calibration steps for spring constant and tip radius are needed before real measurements. QNM mode enables the quantitative measurements of nano-scale material mechanical properties by performing pixelwise force curves in the scanned area. Analysis of the individual force curve data by the AFM Nano-scope software provides a map of material properties with the same resolution of topography image. Here the elastic modulus of the scanned surface was extracted from the force curve using the Derjaguin-Muller-Toropov model and presented in the modulus mapping images.

### Typical Procedure of Hot Mix Asphalt (HMA) Preparation.

Liquid polymer modified bitumen sample was mixed with the hot aggregates in laboratory mixer at 160° C. Successively, upon obtaining HMA from the mixing process, the samples of asphalt mixtures were prepared for further mechanical testing. Stone Mastic Asphalt (SMA) graining was chosen as a recipe for HMA design, which is dedicated for pavements' wearing courses in most countries in Europe.

### Typical Procedure for Indirect Tensile Strength (ITS) Test.

Change of Indirect Tensile Strength (ITS) upon water storage was performed acc. EN 12697-12A. In this method, durability and resistance of a compacted cylindrical asphalt mix slice is checked by the ITS test prior and upon water exposition. The change of ITS is tested on 3 dry samples and 3 samples which have been immersed in water for 24 h at 60° C. Freeze-thaw cycles were also included as a part of conditioning of the wet samples: 1 cycle at −18° C. for 16 h. During the ITS test, the sample was attached between two load stripes and is loaded radially at a speed of 50 mm/min and maximum load at fracture is measured. The relation of the strength values before and after water storage/freeze-thaw cycles is determined, and called Indirect Tensile Strength Ratio (ITSR).

### Typical Procedure for Wheel Tracking Test.

The rutting measurement was performed on small wheel tracking machine acc. EN 12697-22. The machine was equipped with a solid load wheel with an outside diameter of 200 to 205 mm. On the circumference of the wheel, there was a ribbed cast rubber with a rectangular section 50 mm wide and 20±2 mm thick. The wheel of the machine applied a load of 700±10N on the surface of the sample. The device ensured the movement of wheel or sample under the wheel, reciprocating over a section of 230±5 mm with a frequency of 26.5 load cycles for 60 s (a load cycle corresponds to 2 wheel passes: forward and backward). During the test, the following are recorded: test temperature with an accuracy of 1° C., number of wheel passes and rut depth, i.e. wheel recess as measured by the LVDT inductive sensor. The test was carried out until a rut depth of 20 mm or 10,000 cycles of wheel travel was reached. As the result of the test performed in dry conditions (ambient temperature, “in air”), two indices were obtained viz. Proportional Rut Depth (PRD_{AIR}) and Wheel Tracking Slope (WTS_{AIR}).

### Typical Procedure for Quantifying the Adhesion of Asphalt to the Mineral Aggregates (Rolling Bottle Test)

The affinity between the binder and mineral aggregates and the susceptibility of the mixture to stripping was assessed using rolling bottle test method acc. PN-EN 12697-11 (Method A). Two different mineral materials were used viz. (acidic—high SiO₂ content) and limestone (basic—low SiO₂ content) to compare the adhesive properties of the tested binders. Prior to testing, the aggregates were multiply washed and eventually dried to avoid the presence of any dust or contamination. In this method, the 170 g of the given aggregates is heated at 105±5° C. overnight, and coated by a liquefied tested binder (5.7 g) by manual stirring at the 120±5° C. The mixed aggregate-binder system was then left to cool down to the room temperature and stored for 12-24 h prior to performing the rolling bottle test. Subsequently, the glass test bottles were filled with demineralized water to the half of their volume, and 150 g of the binder-coated aggregates of specific origin was added. The so-obtained assembly was then placed on the bottle roller at 60 rotation per minute for 6 h. At the end of the test time, the water was removed from the bottles, and mineral material was transferred into a glass container and successively filled with a portion of demineralized water above the top side of the aggregates' sample to optimize visual assessment of the degree of binder coverage on a given portion of minerals [%] by two distinct observers.

### Typical Procedure for Quantifying the Adhesion of a Binder to the Mineral Aggregates (Boiling Water Test).

Effect of water on bitumen-coated aggregate using boiling water method acc. PN-84/B-06714/22 was included in the test set to determine the adhesion of bitumen and polymer modified bitumen samples to mineral aggregates viz. granite (acidic—high SiO₂ content) and limestone (basic—low SiO₂ content). Prior to testing, the aggregates were multiply washed and eventually dried to avoid the presence of any dust or contamination. In this method, the 100 g of the given aggregates of fraction 6.3/10 [mm] is heated at 150° C. for 1 h and fully coated by tested binder (2.7 g, heated at 150° C. for 10 minutes) by manual stirring at the same temperature. Successively, the coated aggregates were put into the beaker and filled with 135 g of distilled water. The beaker containing aggregates and water was then warmed up using heating plate until boiling point of water was reached. The boiling was continued for 3 minutes, whilst excess of a floating binder was removed using paper towel strips. At the end of the test, water was removed and aggregates were transferred into a white cloth. Visual assessment was performed independently by two observers and percent of aggregates coated with a binder was established, as final result of the test.

### Inductively Coupled Plasma Mass Spectrometry (ICP-MS).

Residual aluminum content in the samples listed in Table 1 was determined by ICP-MS. Approximately 150 mg of each sample was digested in 6 mL concentrated nitric acid (trace metal grade) by microwave assisted acid digestion using an Anton Paar Multiwave PRO equipped with closed high pressure Quartz digestion vessels. After the microwave digestion run, the acid was analytically transferred into a pre-cleaned plastic centrifuge tube containing 1 mL of internal standard solution and is diluted with MilliQ water up to the 50 mL mark. The elements in the sample are quantified using a multi-element calibration set from Inorganic Ventures using an Agilent 8900 ICP-MS system.

### Differential Scanning Calorimetry (DSC).

Thermal analysis was carried out on a DSC Q100 from TA Instruments at a heating rate of 10° C.-min-1. First and second runs were recorded after cooling down to ca. −40° C.

### Nuclear Magnetic Resonance (NMR).

The percentage of functionalization was determined by ¹H NMR analysis carried out at 130° C. using deuterated tetrachloroethane (TCE-D2) as solvent and recorded in 5 mm tubes on a Varian Mercury spectrometer operating at a frequency of 400 MHz. Chemical shifts are reported in ppm versus tetramethylsilane and were determined by reference to the residual solvent protons.

1. A mineral adhesion promoter composition for bitumen comprising
at least of a hydroxyl-functionalized propylene-based terpolymer having a melting temperature (Tm) below 100° C., and
an aluminum-containing residue comprising an elemental aluminum content from a quantity up to 1.5 wt % of the hydroxyl-functionalized propylene-based terpolymer.

2. The mineral adhesion promoter for bitumen in asphalt composition according to claim 1, wherein aluminum-containing residue comprising an elemental aluminum content is an aluminum oxide and/or an aluminum hydroxide and/or an aluminum alkoxide or a mixture thereof.

3. The mineral adhesion promoter for bitumen in asphalt composition according to claim 1, the hydroxyl-functionalized propylene-based copolymer is a polymer comprising propylene, optionally a second olefin monomer and a hydroxyl functionalized olefin.

4. The mineral adhesion promoter for bitumen in asphalt composition according to claim 1, wherein the hydroxyl-functionalized propylene-based copolymer is selected from the list comprising poly(propylene-co-5-hexen-1-ol), poly(propylene-co-ethylene-co-5-hexen-1-ol), poly(propylene-co-1-hexene-co-5-hexen-1-ol) or poly(propylene-co-1-octene-co-5-hexen-1-ol).

5. A modified bitumen composition comprising at least:
a. neat bitumen and
b. the mineral adhesion promoter according to claim 1.

6. The modified bitumen composition according to claim 5, wherein the modified bitumen composition has at least the followings:
Avg. Penetration<80 dmm according to European Standard 1426, and
Avg. softening>46° C. according to European Standard 1427, and
Δ Penetration<9 and/or A Softening point<5 according to European Standard 13399
Adhesion force>40 nN according to SABIC Internal QNM-AFM method
DMT modulus>1.35 GPa according to SABIC Internal QNM-AFM method
Degree of binder coverage on Granite [%]>=80, according to PN-84/B-06714/22,
Degree of binder coverage on Limestone [%]>=60, according to PN-84/B-06714/22,

7. An asphalt composition comprising
the modified bitumen composition according to claim 5, in a quantity of 1.0 to 10 wt % of the asphalt composition, and
mineral in a quantity of 90 to 99.0 wt % of the asphalt composition, and
wherein the asphalt composition have at least the followings:
Coverage of aggregates surface on Granite [%] above 50, according to EN 12697-11 (method A)
Coverage of aggregates surface on Limestone [%] above 70, according to EN 12697-11 (method A)
Indirect tensile strength ratio ITSR [%]>=85, according to EN 12697-12A, and
Wheel tracking slope WTSAIR upon 103 cycles [mm/103 cycles]<0.10, according to EN 12697-22.

8-10. (canceled)
